(19) United States
(12) Patent Application Publication
(10) Pub. No.: US 2018/0066800 A1
(43) Pub. Date: Mar. 8, 2018

(54) CRYOGENIC GAS EQUIPMENT UNIT

(71) Applicant: OPEN JOINT STOCK COMPANY "RUSSIAN RAILWAYS", St Albans (GB)

(72) Inventors: Nikolai Konstantinovich NIKOLSKIY, Kolomna (RU); Valeriy Alekseevich NIKONOV, Kolomna (RU); Andrei Gennadievich VORONKOV, Kolomna (RU); Olga Vladimirovna BYCHKOVA, Kolomna (RU); Maksim Viktorovich KOLOSOV, Kolomna (RU)

(21) Appl. No.: 15/356,411

(22) Filed: Nov. 18, 2016

(30) Foreign Application Priority Data
Sep. 2, 2016 (RU) 2016135675

(51) Int. Cl. F17C 13/00; B61C 5/00; B61C 17/00

(52) U.S. Cl. CPC F17C 13/005; B61C 17/00; B61C 5/00

(57) ABSTRACT

The cryogenic gas equipment unit designed for arrangement and operation of the gas treatment system for locomotives. The unit includes a sheet-lined housing with a power rack. An upper portion of the unit housing has a shape geometrically following the shape of the inner surface of the locomotive body roof. A flooring made of a cold-resistant heat-insulating material is attached to the bottom inside the unit. An aperture is made in one of the side walls of the unit housing. Temperature deformation compensators for cryogenic fuel lines and the cryogenic equipment unit housing are installed in the entry and exit points of the cryogenic fuel lines on the unit housing. A routine inspection of the equipment in the cryogenic gas equipment unit may be carried out through the aperture. In case a piece of the cryogenic gas equipment in the unit fails, the whole unit may be removed and replaced.

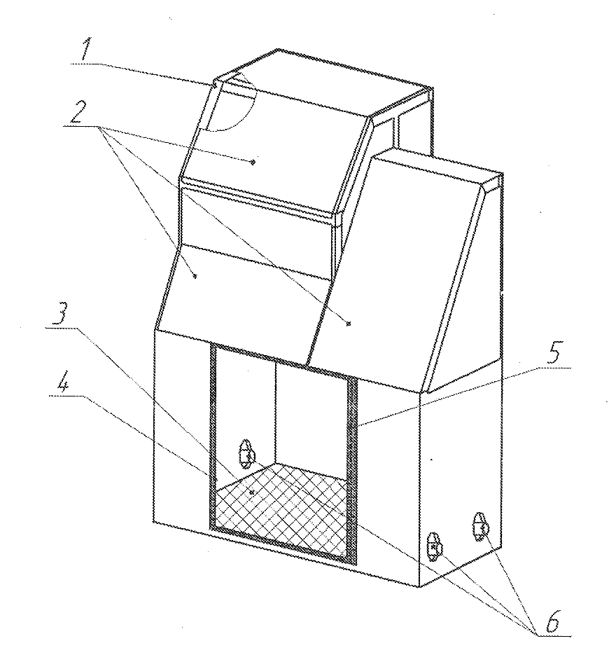

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This invention relates to designs of rolling stock locomotives running on liquefied natural gas (LNG), e.g., gas-turbine locomotives, in particular to the structure of a cryogenic gas equipment unit designed for arrangement and operation of cryogenic equipment included into the gas treatment system for locomotives.

### 2. Description of Related Art Including Information Disclosed Under 37 CFR 1.97 and 37 CFR 1.98

A gas and gas-condensate well survey unit is known (Patent RU 2532050, IPC E21B47/00, publ. Aug. 10, 2014), which is intended for arrangement on a motor vehicle or a trailer without disassembling and further assembling. The unit is located in a rack suitable for arrangement in motor vehicles. The rack for the unit is provided with profiled ribs to make it convenient for transportation, and the gas and gas-condensate well survey unit, as arranged in the rack, is always accessible for servicing shutoff and control valves.

The gas and gas-condensate well survey unit, which is intended for receiving equipment used for surveying gas and gas-condensate wells, may not ensure safety in the conditions of using a cryogenic fuel and may not be used for arrangement of cryogenic gas equipment on gas-turbine locomotives.

### BRIEF SUMMARY OF THE INVENTION

The technical effect of the invention is provision of a cryogenic gas equipment unit which design allows to put it under the roof of a locomotive body, use it for arrangement of cryogenic gas equipment, ensure convenient and less labor-intensive servicing of cryogenic gas equipment as well as explosion safety of a locomotive.

This technical effect is achieved by a cryogenic gas equipment unit that comprises a sheet-lined housing with a power rack, the dimensions of the rack enabling to fit it into the dimensions of a locomotive, and is formed so that the upper portion of the unit housing has a shape geometrically following the shape of the inner surface of the locomotive body roof, a flooring made of a cold-resistant heat-insulating material is attached to the bottom inside the unit, an aperture is made in one of the side walls of the unit housing, which aperture is provided on its periphery with a rim made of an elastic material and tightly adjoining to a rim of an aperture made in a side wall of the locomotive body, temperature deformation compensators for cryogenic fuel lines and the cryogenic equipment unit housing are installed in the entry and exit points of the cryogenic fuel lines on the unit housing.

### BRIEF DESCRIPTION OF THE SEVERAL VIEWS OF THE DRAWINGS

The FIGURE is an accompanying drawing, showing a perspective or axonometric view of the gas equipment unit.

### DETAILED DESCRIPTION OF THE INVENTION

The cryogenic gas equipment unit comprises the unit housing power rack 1 lined with sheets 2, the upper portion of the unit housing has a shape geometrically following the shape of the inner surface of the locomotive body roof, the flooring 3 made of a cold-resistant heat-insulating material is attached to the bottom inside the unit, the aperture 4 is made in one of the side walls of the unit housing, which aperture is provided on its periphery with the rim 5 made of an elastic material and tightly adjoining to the rim of the aperture made in a side wall of the locomotive body, the temperature deformation compensators 6 for the cryogenic fuel lines and the cryogenic equipment unit housing are installed in the entry and exit points of the cryogenic fuel lines on the unit housing.

The invention can be implemented as follows.

The cryogenic gas equipment unit (hereinafter “the unit”) is arranged under the locomotive body roof (not shown in the drawing), and it optimally fits to the locomotive body space owing to the shape of the unit upper portion which geometrically follows the shape of the inner surface of the locomotive body roof. The aperture 4, which is made in one of the unit side walls, is aligned with the corresponding aperture in the side wall of the locomotive body (not shown in the drawing), the rim 5, as made of an elastic material and attached to the periphery of the aperture 4, being in contact with the rim of the aperture made in one side wall of the locomotive body, thus ensuring tight sealing between the unit inner space and the locomotive body inner space. The flooring 3 is attached to the bottom inside the unit housing in order to preclude contact of LNG, if leaked, with the locomotive body frame. The temperature deformation compensators 6, which are made in the form of half-lenses, are installed on the unit housing at the entry and exit points of the cryogenic fuel lines for the purpose of compensating temperature deformations of the cryogenic fuel lines and the cryogenic equipment unit housing.

A routine inspection of the equipment in the cryogenic gas equipment unit may be carried out through the aperture 4.

In a case a piece of the cryogenic gas equipment in the unit fails, the whole unit may be removed and replaced with another unit having fault-free cryogenic gas equipment, which ensures convenience and reduced labor-intensiveness of cryogenic gas equipment maintenance and explosion safety of a locomotive.

Field tests of the cryogenic gas equipment unit in the gas treatment system on a GT1h-002 gas-turbine locomotive proved the above advantages of the proposed invention.

1. A cryogenic gas equipment unit, comprising:
a sheet-lined housing with a power rack, the dimensions of the rack enabling to fit it into the dimensions of a locomotive, wherein an upper portion of the unit housing has a shape geometrically following the shape of the inner surface of the locomotive body roof,
a flooring comprised of a cold-resistant heat-insulating material attached to the bottom inside the unit,
an aperture being made in one of the side walls of the unit housing, which aperture is provided on its periphery with a rim made of an elastic material and tightly adjoining to a rim of an aperture made in a side wall of the locomotive body, and
temperature deformation compensators for cryogenic fuel lines and the cryogenic equipment unit housing are installed in the entry and exit points of the cryogenic fuel lines on the unit housing.
